(19) United States
(12) Patent Application Publication
(10) Pub. No.: US 2008/0126551 A1
(43) Pub. Date: May 29, 2008

(54) CIMOM abstraction layer

(76) Inventors: Christopher Conner, Jonestown, TX (US); Pradeep Kamath, Sunnyvale, CA (US); John Landry, Austin, TX (US); Pallavi Paranjape, Austin, TX (US); Tsen-Loong Peng, Austin, TX (US)

Correspondence Address: HAMILTON & TERRILE, LLP, P.O. BOX 203518, AUSTIN, TX, 78720, US

(21) Appl. No.: 11/461,257

(22) Filed: Jul. 31, 2006

(51) Int. Cl. G06F 15/16

(52) U.S. Cl. 709/230

(57) ABSTRACT

An improved system and method is disclosed for transparent and agent-less remote access to CIMOMs and the management information they provide, regardless of the CIMOM communication protocol implemented. Differences between disparate CIM object manager (CIMOM) implementations are abstracted to provide clients a common interface when accessing information management data. A protocol layer is implemented that comprises protocol adapters that are dynamically loaded to handle communications with WBEM implementation. Target CIMOM protocols are discovered on-line by the protocol layer, which provides the appropriate interface to transparently convey management information from the CIMOM to the abstraction layer.

### BACKGROUND OF THE INVENTION

1. Field of the Invention

The present invention relates in general to the field of information handling systems and more specifically, to system management.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems continue to grow in power, capabilities and variety, and with the advent of the Internet, they have also become more numerous and more distributed. As a result, their management has become increasingly complex, in part due to the growing heterogeneity of the elements that comprise them and the diversity of their associated management environments. In response, the Distributed Management Task Force (DMTF) has developed frameworks that facilitate the interoperable exchange of management information between managed elements and corresponding management systems. One of these frameworks is the Common Information Model (CIM), which provides a consistent definition and structure of management information through the use of object-oriented techniques. As a conceptual information model, the CIM is structured such that managed environments can be viewed as collections of interrelated systems, each of which is comprised of a number of discrete elements.

The CIM, comprised of a specification and a schema, allows management-related information about these elements to be transparently exchanged between management systems. The specification describes an object-oriented meta model based on the Unified Modeling Language (UML) and defines how the CIM can be integrated with other management models. These include, but are not limited to, Simple Network Management Protocol (SNMP) Management Information Base (MIB) or DMTF Management Information Format (MIF). The CIM schema provides a set of classes with properties, methods and associations that define how managed elements in an environment are represented as a common set of objects. In the CIM model, managed objects such as processors, sensors and fans are presented as CIM classes, with the relationships between these managed objects presented through association classes. This hierarchical, object-oriented architecture facilitates the tracking and depiction of the often complex interdependencies and associations between managed objects. Interaction between managed elements and management systems is further facilitated by the CIM object manager (CIMOM), which supports services such as event notification, remote access, and query processing.

Another framework developed by the DMTF is Web-Based Enterprise Management (WBEM), a set of management and Internet technologies developed to unify the management of distributed computing environments. WBEM provides an integrated set of management tools that facilitate the exchange of data across otherwise disparate technologies and platforms. However, remote communication with WBEM-based CIMOMs is limited by non-standardized communication protocols. For example, Windows Management Instrumentation (WMI) uses the Distributed Component Object Manager (DCOM) protocol. OpenWBEM uses CIM-XML over HTTP and Web Services Manager (WS-Man) uses Simple Object Access Protocol (SOAP). Currently, the most commonly used protocols are WMI on Windows and CIM-XML over HTTP on Linux. Other emerging implementations include Web Service Distributed Management (WSDM) provided by the OASIS consortium. Existing approaches to addressing this issue include proprietary, single protocol solutions or implementation of an agent on all managed servers/nodes. In view of the foregoing, an improved system and method is needed to transparently access data stored in WBEM implementations regardless of the protocol required.

### SUMMARY OF THE INVENTION

In accordance with the present invention, an improved system and method is disclosed for transparent and agent-less remote access to CIMOMs and the management information they provide, regardless of the CIMOM communication protocol implemented. In different embodiments of the invention, differences between disparate CIMOM implementations are abstracted to provide clients a common interface when accessing information management data. In these embodiments of the invention, a common application program interface (API) is implemented within an extensible protocol framework such that CIMOM functionality is transparent to the client, regardless of its associated operating system or how it is implemented.

The common API comprises an abstraction layer and is the point of integration for clients accessing WBEM data. This layer comprises a standard API for transparently communicating with all WBEM implementations (e.g., OpenWBEM, WMI, etc.). In one embodiment of the invention, a protocol layer is implemented that comprises protocol adapters that are dynamically loaded by a protocol loader from a predetermined directory of protocol libraries to handle communications with WBEM implementation. In another embodiment of the invention, protocols are static and loaded as required. In these embodiments of the invention, protocol adapters can be loaded and removed by adding and removing the protocol libraries from the aforementioned directory.

These CIMOM implementations can reside on any operating system including, but not limited to, Microsoft Windows and Linux. In an embodiment of the invention, target CIMOM protocols are discovered on-line by the protocol layer, which provides the appropriate interface to transparently convey management information from the CIMOM to the abstraction layer. The discovery component of the protocol layer will detect the correct protocol for the CIMOM server by iterating loaded protocol adapters in the aforementioned directory until the appropriate protocol is identified. There is a standard interface for protocols, allowing their implementation to be transparent to the abstraction layer as well. The abstraction layer does not require knowledge of the underlying implementations. Those of skill in the art will understand that many such embodiments and variations of the invention are possible, including but not limited to those described hereinabove, which are by no means all inclusive.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a generalized illustration of an information handling system that can be used to implement the method and apparatus of the present invention;

FIG. 2 is a generalized block diagram of Common Information Model Object Manager (CIMOM) extensible protocol adapter framework as implemented in accordance with an embodiment of the invention;

FIG. 3 is a generalized Unified Modeling Language (UML) diagram of a protocol abstraction layer of a CIMOM extensible protocol adapter framework as implemented in accordance with an embodiment of the invention;

FIG. 4 is a generalized UML diagram of a CIMOM protocol adapter as implemented in accordance with an embodiment of the invention;

FIG. 5 is a generalized flowchart of a CIMOM protocol loader system as implemented in accordance with an embodiment of the invention;

FIG. 6 is a generalized flowchart of a CIMOM protocol discovery system as implemented in accordance with an embodiment of the invention; and

FIG. 7 is a generalized flowchart of a CIMOM extensible protocol adapter framework as implemented in accordance with an embodiment of the invention.

### DETAILED DESCRIPTION

An improved system and method is disclosed for transparent and agent-less remote access to CIMOMs and the management information they provide, regardless of the CIMOM communication protocol implemented. In different embodiments of the invention, differences between disparate CIM object manager (CIMOM) implementations are abstracted to provide clients a common interface when accessing information management data. In one embodiment of the invention, a protocol layer is implemented that comprises protocol adapters that are dynamically loaded to handle communications with different WBEM implementations. In another embodiment of the invention, target CIMOM protocols are discovered on-line by the protocol layer, which provides the appropriate interface to transparently convey management information from the CIMOM to the abstraction layer.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

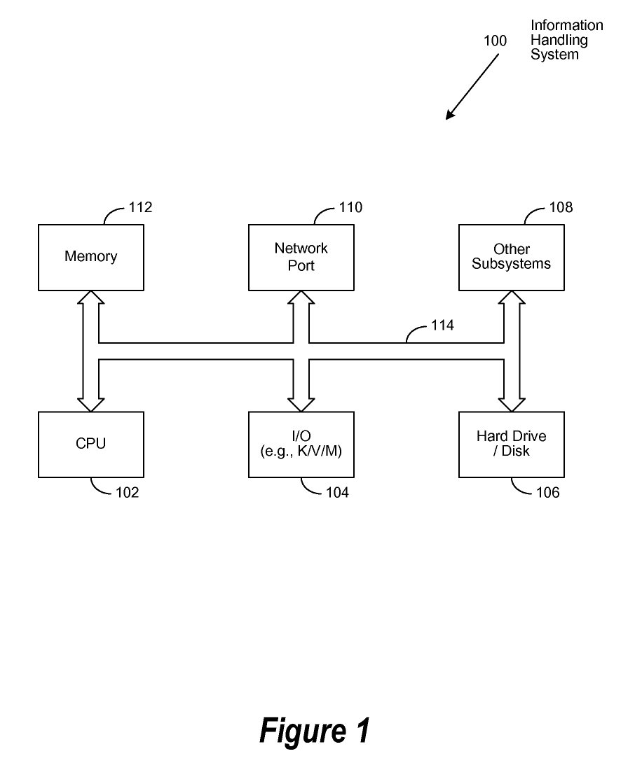

FIG. 1 is a generalized illustration of an information handling system 100 that can be used to implement the system and method of the present invention. The information handling system includes a processor (e.g., central processor unit or “CPU”) 102, input/output (I/O) devices 104, such as a display, a keyboard, a mouse, and associated controllers, a hard drive or disk storage 106, various other subsystems 108, network port 110, and system memory 112, all interconnected via one or more buses 114.

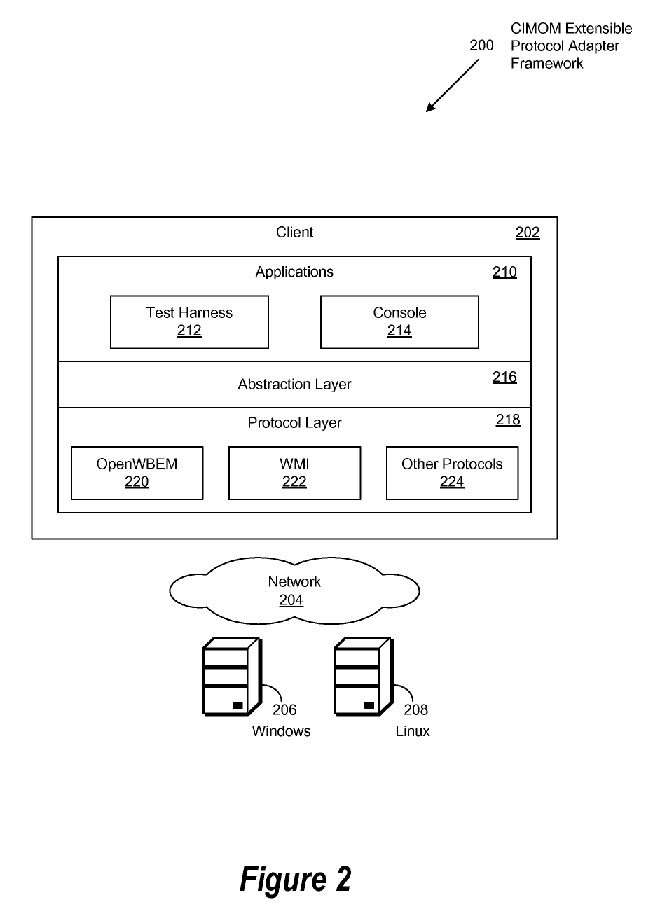

FIG. 2 is a generalized block diagram of Common Information Model Object Manager (CIMOM) extensible protocol adapter framework 200 as implemented in accordance with an embodiment of the invention. In this embodiment, CIMOM client 202 communicates over network 204 to Windows-based CIMOM 206 or Linux-based CIMOM 208. CIMOM client 202 is comprised of applications 210, abstraction layer 216, and Web Based Enterprise Management (WBEM) protocols 218. Applications 210 include, but are not limited to, test harness 212 and console 214. WBEM protocols 218 include, but are not limited to, OpenWBEM 220, Windows Management Instrumentation (WMI) 222, and other protocols 224 known to those of skill in the art.

In different embodiments of the invention, differences between disparate WBEM-based CIMOM implementations 206, 208 are abstracted to provide CIMOM client 202 a common interface when accessing information management data. In these embodiments of the invention, a common application program interface (API) is implemented such that WBEM functionality is transparent to the client, regardless of its associated operating system or how it is implemented. The common API comprises abstraction layer 216 and is the point of integration for clients to transparently access WBEM data through CIMOM implementations 206, 208.

Protocol layer 218 comprises pluggable protocol adapters 220, 222, 224, operable to support communications with CIMOM implementations 206, 208, and can reside on any operating system including, but not limited to, Microsoft Windows and Linux. In an embodiment of the invention, protocol layer 218 implements a common API for protocols 220, 222 and other protocols 224, such that their implementation is transparent to abstraction layer 216. In these and other embodiments of the invention, protocol layer 218 transparently conveys CIM management information transmitted and received by protocols 220, 222 and other protocols 224 to the abstraction layer.

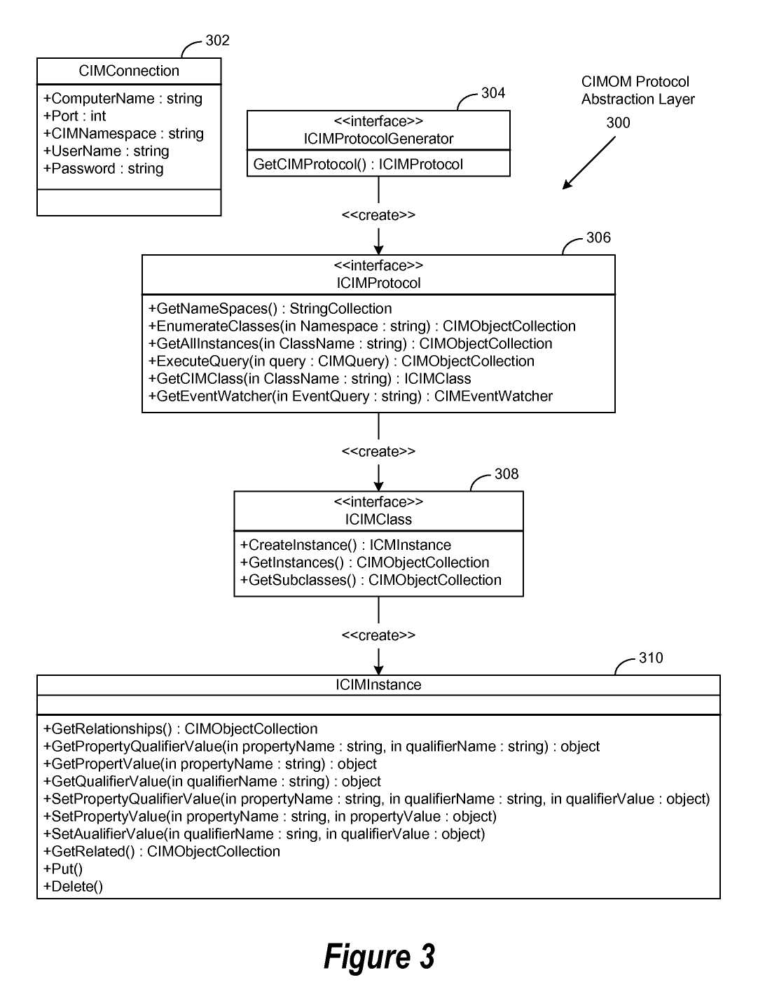

FIG. 3 is a generalized Unified Modeling Language (UML) diagram of a protocol abstraction layer 300 of a CIMOM extensible protocol adapter framework as implemented in accordance with an embodiment of the invention. In this embodiment, a CIM-based connection 302 is established with ICIMProtocolGenerator abstraction layer 304 to implement the appropriate protocol. The abstraction layer creates the required protocol adapter dependent upon the predetermined implementation of the interface.

In one embodiment of the invention, protocol adapters are dynamically loaded. In another embodiment of the invention, protocol adapters are static. In one embodiment of the invention, ICIM Protocol Generator 304 dynamically generates an appropriate protocol by implementing ICIMProtocol interface 306, which gathers interface requirements to create an ICIMClass 308, which in turn creates ICIMInstance 310. Those of skill in the art will be aware that in CIMOM implementations the class represents the schema and the instance represents instances of a class, and by extension, each instance is an instance of the super class.

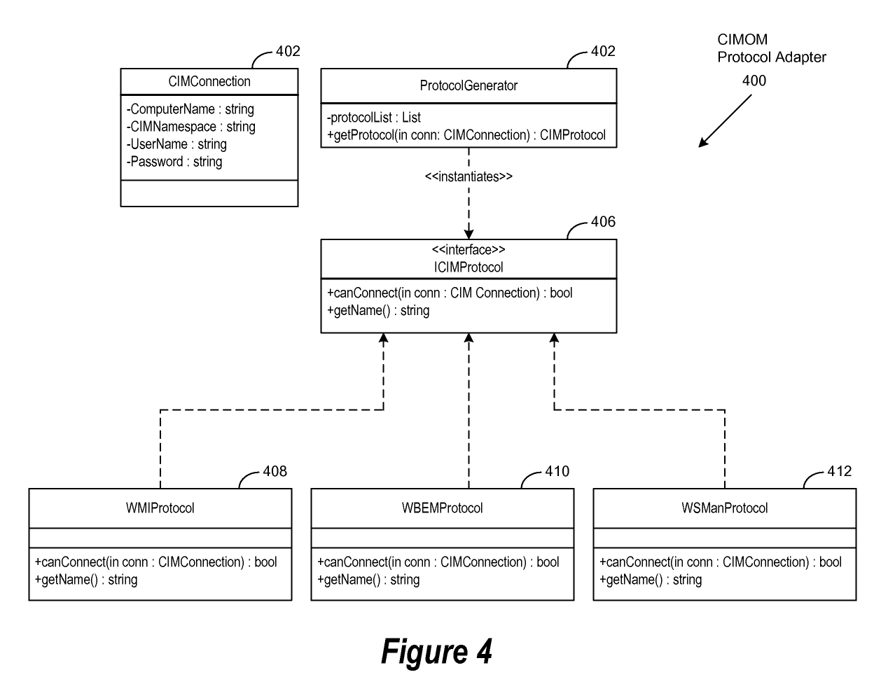

FIG. 4 is a generalized UML diagram of a CIMOM protocol adapter 400 as implemented in accordance with an embodiment of the invention. In this embodiment of the invention, a CIM-based connection 402 is established with ProtocolGenerator abstraction layer 404 to implement the appropriate protocol. In embodiments of the invention, ProtocolGenerator abstraction layer 404 instantiates ICIMProtocol loader 406 to dynamical loads the required protocol adapter such as, but not limited to, WMIProtocol 408, WBEMProtocol 410, WSManProtocol 412, dependent upon the predetermined implementation of the interface. In another embodiment of the invention, the required protocol adapter is static, but can be loaded or unloaded as required by ICIMProtocol loader 406.

In an embodiment of the invention, a programmable protocol interface is specified that is implemented to provide additional protocols. In this embodiment of the invention, ICIMProtocol loader 406 loader searches a predetermined directory for protocol libraries. The libraries in the directory are loaded and searched for classes that implement the desired protocol interface. Protocol adapters can be added and removed by adding or removing the protocol library files from the directory.

In an embodiment of the invention, a discovery component detects the correct protocol for a server given an IP address for the server. The protocol interface comprises a method called “canConnect.” A protocol discovery algorithm comprising ICIMProtocol loader 406 iterates the loaded protocol adapters and invokes the “canConnect” method until the appropriate protocol is detected. The appropriate protocol adapter can then be used by the application to communicate with the target CIMOM server.

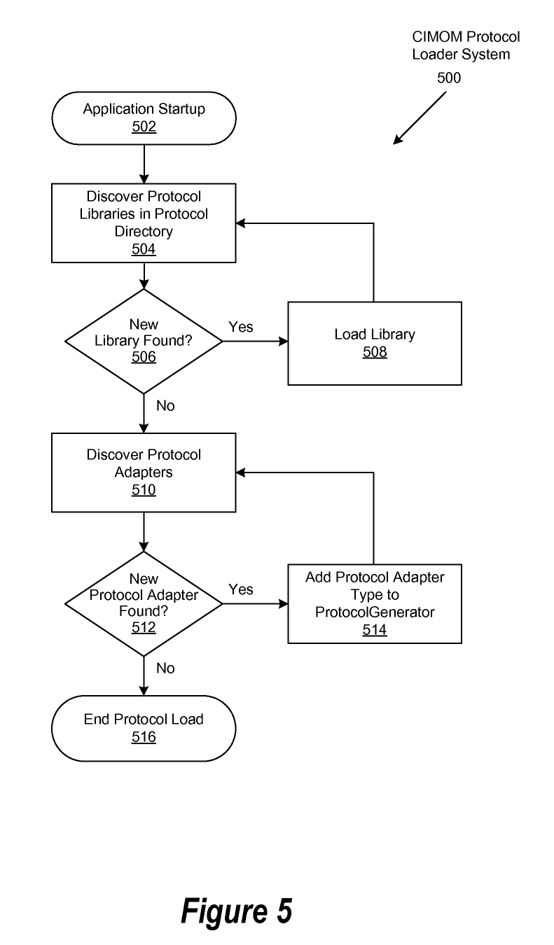

FIG. 5 is a generalized flowchart of a CIMOM protocol loader system 500 as implemented in accordance with an embodiment of the invention. In step 502, the CIMOM protocol loader system is started and discovery of protocol libraries in a protocol directory begins in step 504. If a new protocol library is discovered in step 504, it is loaded into the CIMOM protocol loader in step 508, with the protocol discovery process continuing in step 504 until all new protocol libraries have been discovered. Once all new protocol libraries have been discovered in the preceding process, discovery of protocol adapters begins in step 510. If a new protocol adapter is discovered in step 512, then the protocol adapter type is added to the ProtocolGenerator in step 514, with the protocol adapter discovery process continuing in step 510 until all new protocol adapters have been discovered, at which time protocol loading is ended in step 516.

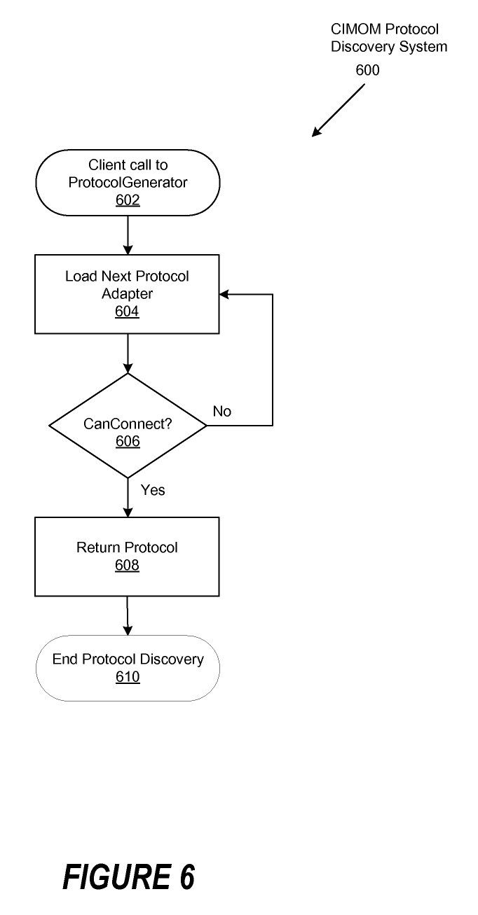

FIG. 6 is a generalized flow chart of a CIMOM protocol discovery system 600 as implemented in accordance with an embodiment of the invention. In step 602, a CIM client places a call to a ProtocolGenerator abstraction layer, which instantiates a protocol loader in step 604 to load the next protocol adapter in a predetermined directory comprising protocol adapters. If it is determine in step 606 that the loaded protocol adapter is able to invoke a “canConnect” method, then the protocol is returned in step 608 and protocol discovery is ended in step 610. If it is determine in step 606 that the loaded protocol adapter is not able to invoke a “canConnect” method, then the next protocol adapter is loaded in step 604 and the process is repeated until the appropriate protocol is returned in step 608 and protocol discovery is ended in step 610.

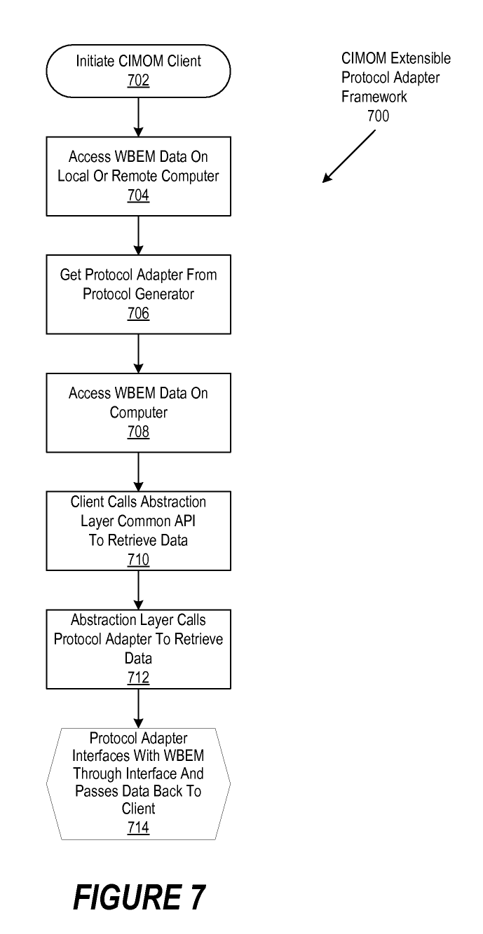

FIG. 7 is a generalized flowchart of a CIMOM extensible protocol adapter framework 700 as implemented in accordance with an embodiment of the invention. In this embodiment of the invention, a CIMOM client is initiated in step 702 to access WBEM data on a local or remote computer in step 704. In step 706, the CIMOM client uses a WBEM protocol adapter retrieved from a protocol Generator to access WBEM data on a predetermined computer in step 708. In step 710, the CIMOM client calls the abstraction layer to retrieve WBEM data, and in turn, the abstraction layer calls a predetermined protocol adapter to retrieve WBEM data in step 712. In step 714, the protocol adapter interfaces with the WBEM implementation through its interface and passes the requested WBEM data back to the client.

What is claimed is:

1. A system for communicating information between a plurality of information handling systems, comprising:
a plurality of common-information-model object managers (CIMOMS) operable to define relationships between classes and subclasses of managed elements, said plurality of CIMOMs operable to communicate using a plurality of protocols; and
an application program interface (API) providing an extensible protocol framework operable to provide a common interface for transferring information between said plurality of CIMOMs.

2. The system of claim 1, wherein said API is implemented in an abstraction layer.

3. The system of claim 2, wherein said API is operable to implement a protocol layer comprising a protocol library.

4. The system of claim 3, wherein said protocol layer further comprises a plurality of static protocol adapters.

5. The system of claim 3, wherein said protocol layer further comprises a plurality of dynamic protocol adapters that are dynamically loaded by a protocol loader.

6. The system of claim 3, wherein said protocol layer is operable to discover target CIMOM protocols.

7. The system of claim 6, wherein said protocol layer is further operable to associate a predetermined protocol adapter with a CIMOM protocol discovered by said protocol layer.

8. The system of claim 7, wherein said protocol adapter comprises a Web-Based Enterprise Management (WBEM) protocol.

9. The system of claim 7, wherein said protocol adapter comprises a Windows Management Instrumentation (WMI) protocol.

10. The system of claim 7, wherein said protocol adapter comprises a Web Services Management (WS-Man) protocol.

11. A method for communicating information between a plurality of information handling systems, comprising:
using a plurality of common-information-model object managers (CIMOMs) to define relationships between classes and subclasses of managed elements, said plurality of CIMOMs operable to communicate using a plurality of protocols; and
using an application program interface (API) to provide a common interface for transferring information between said plurality of CIMOMs, said API comprising an extensible protocol framework.

12. The method of claim 11, further comprising implementing said API in an abstraction layer.

13. The method of claim 12, wherein said API is operable to implement a protocol layer comprising a protocol library.

14. The method of claim 13, wherein said protocol layer further comprises a plurality of static protocol adapters.

15. The method of claim 13, wherein said protocol layer further comprises a plurality of dynamic protocol adapters that are dynamically loaded by a protocol loader.

16. The method of claim 13, further comprising using said protocol layer to discover target CIMOM protocols.

17. The method of claim 16, further comprising using said protocol layer to associate a predetermined protocol adapter with a CIMOM protocol discovered by said protocol layer.

18. The method of claim 17, wherein said protocol adapter comprises a Web-Based Enterprise Management (WBEM) protocol.

19. The method of claim 17, wherein said protocol adapter comprises a Windows Management Instrumentation (WMI) protocol.

20. The method of claim 17, wherein said protocol adapter comprises a Web Services Management (WS-Man) protocol.
